(19) United States
(12) Patent Application Publication
(10) Pub. No.: US 2023/0283667 A1
(43) Pub. Date: Sep. 7, 2023

(54) Method and Apparatus to Centrally Control and Process Multiple Sensors

(71) Applicants: Ramesh Annavajjala, Natick, MA (US); Kuntal Chowdhury, Andover, MA (US)

(72) Inventors: Ramesh Annavajjala, Natick, MA (US); Kuntal Chowdhury, Andover, MA (US)

(21) Appl. No.: 17/667,612

(22) Filed: Feb. 9, 2022

(51) Int. Cl. H04L 67/12; H01Q 21/06; G01S 7/02

(52) U.S. Cl. CPC H04L 67/12; G01S 7/0236; H01Q 21/061; G06K 9/6289

(57) ABSTRACT

A plurality of sensors are controlled and processed by an electronic control unit (ECU). Each sensor compresses the raw data samples, encapsulates them into IP packets, and transmits them to the ECU over the Ethernet transport. The ECU decompresses the IP packets, and individually performs sensor-specific signal processing prior to performing multi-modal sensor fusion. Additionally, if the underlying sensor is a Radar sensor, the ECU performs interference detection, interference mitigation, interference management, transmits compressed beamforming weights to enable transmit beamforming on the Radar sensor.

### DETAILED DESCRIPTION OF THE INVENTION

The embodiments of our invention provide method for central control and processing of a plurality of radar sensors mounted on stationary or moving platforms. Examples of stationary platforms include walls, utility poles, and cellular towers. Examples of moving platforms include automobiles, ships, manned and unmanned aerial vehicles.

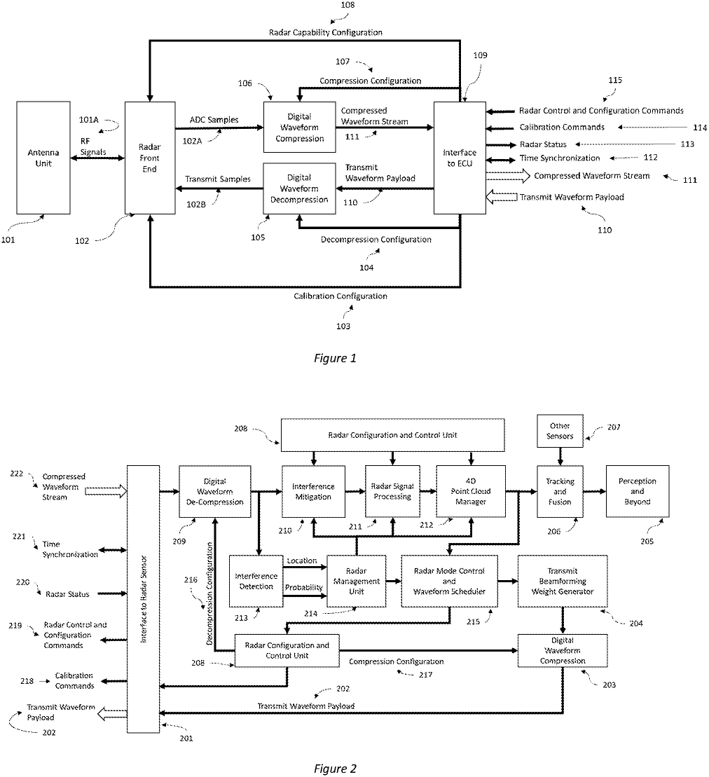

FIG. 1 shows a radar sensor including the blocks Antenna Unit 101, Radar Front End 102, Digital Waveform Compression 106, Digital Waveform Decompression 105, and an Interface to ECU 109 according to the embodiments of our invention.

The Interface to the ECU 109 receives Radar Control and Configuration Commands 115, Calibration Commands 114, Transmit Waveform Payload 110, and Receive Compressed Waveform Stream 111 from the Digital Waveform Compression 106.

The Interface to the ECU 109 transmits Radar Status 113, Compressed Waveform Stream 111, Transmit Waveform Payload 110, Compression Configuration 107, Radar capability Configuration 108, Decompression Configuration 104, and Calibration Configuration 103.

The Interface to the ECU 109 transmits and receives Time-Synchronization 112

The Digital Waveform Compression 106 receives the data from the Radar Front End 102, receives Compression Configuration 107 from the Interface to the ECU 109, performs digital waveform compression, and transmits the Compressed Waveform Stream 111 to the Interface to the ECU 109.

The Digital Waveform Decompression 105 receives Transmit Waveform Payload 110 and Decompression Configuration 104 from the Interface to the ECU 109, performs digital waveform decompression, and transmits the Transmit Samples 102B to the Radar Front End 102.

The Radar Front End 102 receives the Transmit Samples 102B, Calibration Configuration 103, and Radar Capability Configuration 108, and transmits the ADC Samples 102A.

The Radar Front End 102 transmits RF Signals 101A to the Antenna Unit.

The Radar Front End 102 receives RF Signals 101A from the Antenna Unit.

FIG. 2 shows ECU signal processing including Interface to Radar Sensor 201, Radar Configuration and Control Unit 208, Waveform De-Compression 209, Interference Mitigation 210, Interference Detection 213, Radar Signal Processing 211, 4D Point Cloud Management 212, Radar Management Unit 214, Radar Mode Control and Waveform Scheduler 215, Transmit Beamforming Weight Generation 204, Transmit Waveform Compression 203, Tracking and Fusion 206, Other Sensors 207, and Perception and Beyond 205 according to the embodiments of our invention.

From the radar sensor described in FIG. 1, The Interface to Radar Sensor 201 receives Compressed Waveform Stream 222 and Radar Status 220.

The Interface to Radar Sensor 201 transmits Calibration Commands 218, Radar Control and Configuration Commands 219, and Transmit Waveform Payload 202, to the radar sensor described in FIG. 1.

The Interface to Radar Sensor 201 transmits Time Synchronization 221 to the radar sensor described in FIG. 1.

The Interface to Radar Sensor 201 receives Time Synchronization 221 from the radar sensor described in FIG. 1.

Digital Waveform De-Compression 209 receives Compressed Waveform Stream 222 and Decompression Configuration 216, performs digital waveform decompression and transmits decompressed waveform stream to Interference Mitigation 210 and Interference Detection 213.

Interference Detection 213 receives decompressed waveform stream to detect the presence of interference in the decompressed waveform stream.

Interference Detection 213 transmits Location and Probability of the interference presence in the decompressed waveform stream.

Radar Management Unit 214 receives Location and Probability of interference and configures the Interference Mitigation 210, Radar Mode Control and Waveform Scheduler 215, Radar Signal Processing 211, 4D Point Cloud Manager 212.

Radar Mode Control and Waveform Scheduler 215 receives configuration from Radar Management Unit 214, a list of targets in range, Doppler, azimuth and elevation dimensions by the 4D Point Cloud Manager 212, and configures Radar Configuration and Control Unit 208.

Transmit Beamforming Weight Generator 204 receives configuration from Radar Mode Control and Waveform Scheduler 215 and produces a digital beamformed waveform stream.

Digital Waveform Compression 203 receives Compression Configuration 217 from Radar Configuration and Control Unit 208 and digital beamformed waveform stream from Transmit Beamforming Weight Generator 204 to produce a compressed version of the digital beamformed waveform stream.

Transmit Waveform Payload 202 is transmitted from Digital Waveform Compression 203 to Interface to Radar Sensor 201.

Radar Configuration and Control Unit 208 received configuration from Radar Mode Control and Waveform Scheduler 215, transmits Calibration Commands 218, Radar Control and Configuration Commands 219, Decompression Configuration 216, and Compression Configuration 217.

Radar Configuration and Control Unit 208 configures Interference Mitigation 210, Radar Signal Processing 211, and 4D Point Cloud Manager 212.

Radar Signal Processing 211 receives interference-mitigated samples from Interference Mitigation 210 and transmits target returns to 4D Point Cloud Manager 212. Each detected target return contains 4-dimensional target returns in range, Doppler, azimuth and elevation angles along with other information such as radar cross section (RCS) and signal-to-noise ratio (SNR).

4D Point Cloud Manager 212 receives the list of targets from Radar Signal Processing 211, performs clustering and classification to reduce the noise, and transmits the cluster of detected objects to Tracking and Fusion 206 and Radar Mode Control and Waveform Scheduler 215.

Tracking and Fusion 206 receives the cluster of detected objects from 4D Point Cloud Manager 212 and a list of detections and tracks from Other Sensors 207 to perform multi-sensor tracking.

Perception and Beyond 205 receives fused tracks from Tracking and Fusion 206, implements various perception algorithms to create a perception of the world around the sensors.

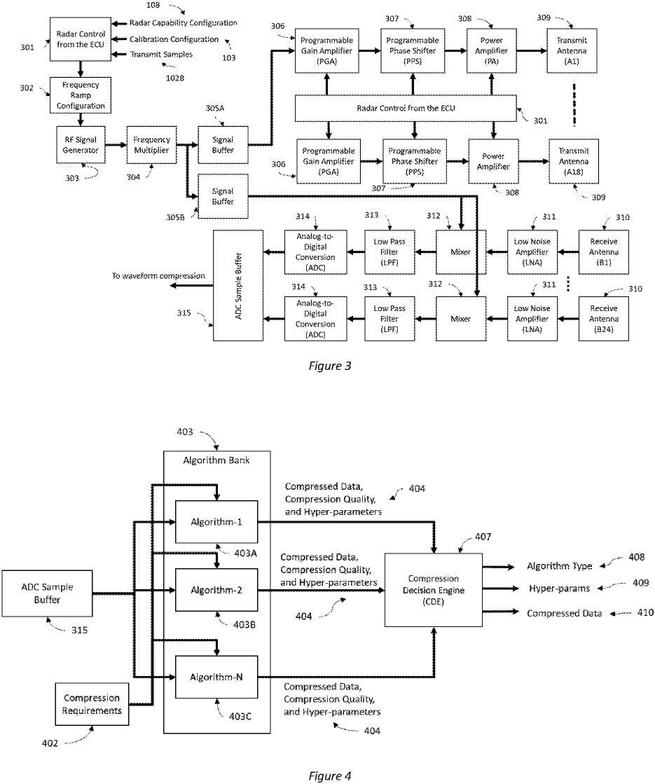

FIG. 3 shows radar front end including Radar Control from the ECU 301, Frequency Ramp Configuration 302, RF Signal Generator 303, Frequency Multiplier 304, Signal Buffer 305, Programmable Gain Amplifier 306, Programmable Phase Shifter (PPS) 307, Power Amplifier 308, Transmit Antenna 309, Receive Antenna 310, Low Noise Amplifier (LNA) 311, Mixer 312, Low Pass Filter (LPF) 313, ADC 314, and ADC Sample Buffer 315 according to the embodiments of our invention.

Radar Control from the ECU 301 receives radar operating configuration settings from Radar Capability Configuration 108, calibration commands from Calibration Configuration 103, and digital waveform samples from Transmit Samples 102B. Examples of digital waveform samples include beamforming weights, transmission masks, phase shifter values and amplitude values.

Radar Control from the ECU 301 configures Frequency Ramp Configuration 302. Example configurations include starting frequency, ending frequency, center frequency, ramp bandwidth, and ramp time.

Frequency Ramp Configuration 302 transmits the frequency ramp generation settings to RF Signal Generator 303.

RF Signal Generator 303 produces an RF signal and sends this to Frequency Multiplier 304.

Frequency Multiple 304 multiplies the incoming RF signal frequency by a factor to produce a higher frequency output which is sent to Signal Buffer 305A and Signal Buffer 305B.

Signal Buffer 305A sends its output signal to Programmable Gain Amplifier (PGA) 306. PGA 306 changes the amplitude of the incoming signal based on a configured amplitude value.

PGA 306 sends its output signal to Programmable Phase Shifter (PPS) 307. PPS 307 changes the phase of the incoming signal based on a configured phase value.

On each of the 18 transmit paths, Radar Control from the ECU 301 configures the PGA 306 with an amplitude value, Programmable Phase Shifter (PPS) 307 with a phase value, and Power Amplifier (PA) 308 with a power level.

On each of the 18 transmit paths, Power Amplifier (PA) 308 amplifies the RF signal received from PPS 308.

On each of the 18 transmit paths, PA 308 output is fed to the Transmit Antenna 309.

Transmit Antenna 309 radiates the RF signal.

On each of the 24 receive paths, Receive Antenna 310 receives RF signal over the air, and feeds it to the Low Noise Amplifier (LNA) 311. The LNA 311 output along with the local RF signal from the Signal Buffer 305B is sent to a Mixer 312. The Mixer 312 performs downconversion by multiplying the LNA 312 output with the local RF signal. The output of Mixer 312 is sent to Low Pass Filter (LPF) 313. LPF 313 filters out high-frequency terms and keeps only those frequency components that are within the LPF 313 bandwidth. The LPF 313 output is sent to Analog-to-Digital Conversion (ADC) 314. The ADC 314 digitizes each analog sample and sends the digital word to ADC Sample Buffer (315).

ADC Sample Buffer (315) collects the digital words from each of the 24 ADC 314 blocks. The output of ADC Sample Buffer is sent to waveform compression.

FIG. 4 shows digital waveform compression including ADC Sample Buffer 315, Compression Requirements 402, Algorithm Bank 403, and Compression Decision Engine (CDE) 407 according to the embodiments of our invention.

Compression Requirements 402 is configured with a set of compression requirements. Examples include compression ratio, lossless vs lossy compression mode, lossless compression algorithm name, lossless compression algorithm parameters, lossy compression algorithm name, lossy compression algorithm parameters, tolerable delay, memory requirements, and computational burden.

Algorithm Bank 403 consists of a plurality of algorithms Algorithm-1 403A, Algorithm-2 403B, and Algorithm-N 403C. The algorithm bank can be populated with an arbitrary number of algorithms.

Each algorithm configured in Algorithm Bank 403 processes the waveform samples from the ADC Sample Buffer 315 based on the compression requirements configured in 402. Each algorithm transmits its Compressed Data, Compression Quality, and Hyper-parameters 404 to the Compression Decision Engine (CDE) 407.

The CDE 407 picks the best algorithm based on the compression quality reported by each one of the compression algorithms present in the Algorithm Bank 403. From the best algorithm chosen, CDE 407 outputs Algorithm Type 408, Hyper-parameters 409, and Compressed Data 410.

FIG. 5 shows digital waveform de-compression including Algorithm Router 502A and Algorithm Bank 504 according to the embodiments of our invention.

Algorithm Router 502A takes inputs Compressed Data 501, Algorithm Type 502, and Hyper-parameters 503 as inputs. Algorithm Type can be any one of the N algorithms, Algorithm-1 through Algorithm-N, that are pre-configured in the Algorithm Bank. Based on the value taken by the Algorithm Type, Algorithm Router feed the Compressed Data and the Hyper-parameters to one of the N algorithm blocks present in the Algorithm Bank.

Algorithm-1 504A processes the Compresses Data with Hyper-parameters if Algorithm Type is set to “algorithm-1” to produce reconstructed ADC samples.

Algorithm-2 50BA processes the Compresses Data with Hyper-parameters if Algorithm Type is set to “algorithm-2” to produce reconstructed ADC samples.

Algorithm-N 504C processes the Compresses Data with Hyper-parameters if Algorithm Type is set to “algorithm-n” to produce reconstructed ADC samples.

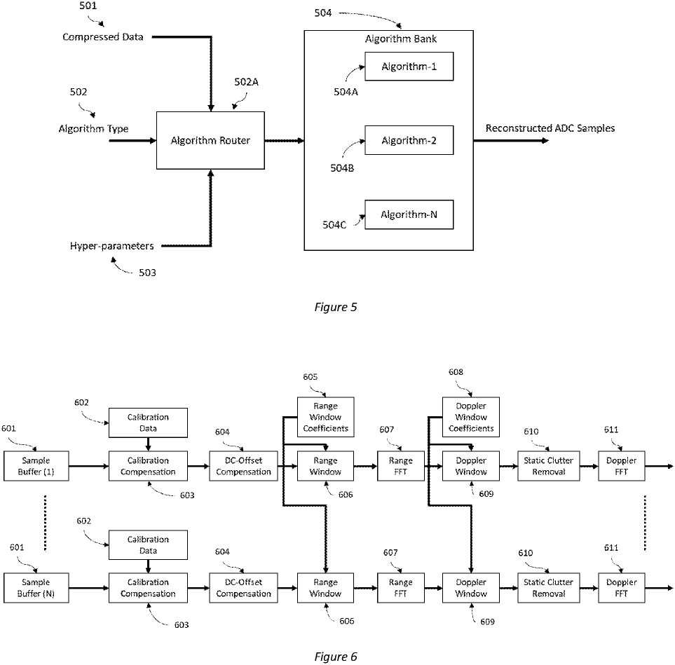

FIG. 6 shows as many as 24 channels range-Doppler signal processing on the ECU including Sample Buffer 601, Calibration Data 602, Calibration Compensation 603, DC-Offset Compensation 604, Range Window Coefficients 605, Range Window 606, Range FFT 607, Doppler Window Coefficients 608, Doppler Window 609, Static Clutter Removal 610, and Doppler FFT 611 according to the embodiments of our invention.

Complex-valued ADC data received on receive antenna channel n is stored in Sample Buffer (n). There are as many as 24 ADC channels.

Calibration Compensation 603 block receives the ADC samples from Sample Buffer (1) 601 and antenna calibration data over all the 18 transmit antennas from Calibration Data 602, to perform calibration compensation. This compensation is performed separately for each sample in the ADC buffer.

After the calibration compensation is done, DC-Offset Compensation 604 removes the DC offset present in each received pulse. This compensation is performed separately for each pulse.

Window operation over a block of samples is defined as element-by-element multiplication of samples within the block by a pre-defined block of window coefficients. The length of the block of window is the same as the length of the block of samples.

Range Window 606 block performs window operation over a block of samples received from 604 and the window coefficients stored in 605.

Range FFT 607 is performed over a block of samples received from 606. The range FFT length is not smaller than N, where N is the length of block of samples.

After the range FFT is performed, for each range FFT bin, Doppler window coefficients are applied by 609 across a block of pulses received from 607. Doppler window coefficients are stored in 608.

Static clutter removal is performed over the Doppler window data 609 by 610.

For each range bin, Doppler FFT is performed over a block of pulses by 611. The Doppler FFT size is not smaller than K, where K is the number of pulses in the block.

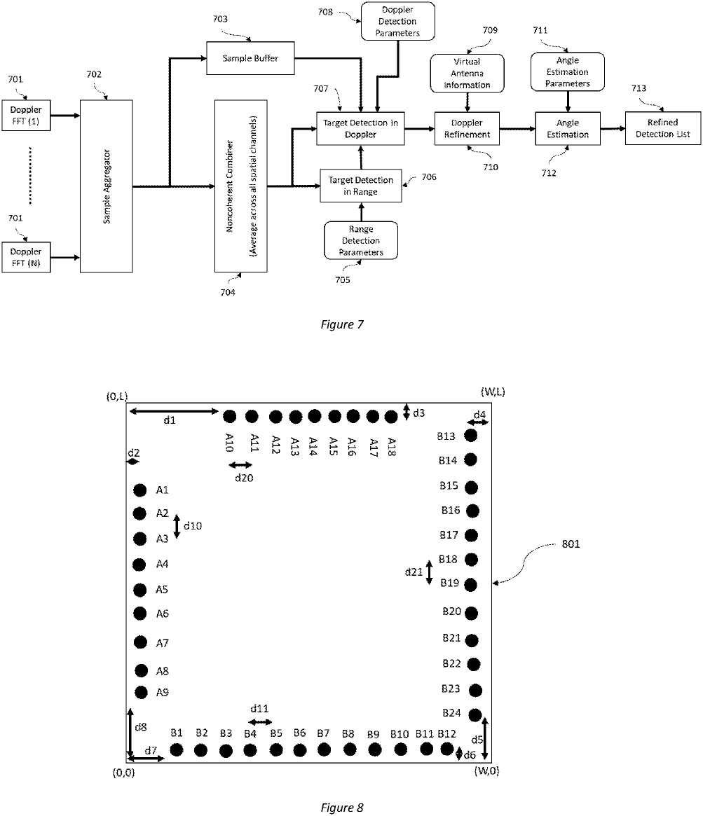

FIG. 7 shows range-Doppler-angle estimation processing on the ECU including Sample Aggregation 702, Sample Buffer 703, Noncoherent Combiner 704, Target Detection in Range 706, Target Detection in Doppler 707, Range Detection Parameters 705, Doppler Detection Parameters 708, Velocity Refinement 710, Virtual Antenna Information 709, Angle Estimation Parameters 711, Angle Estimation 712, and Detection List 713 according to the embodiments of our invention.

Doppler FFT of a particular receive antenna channel is stored in 701. There are up to 24 receive antenna channels. Starting with the Doppler FFT data from up to 24 channels, Range, Doppler, azimuth and elevation information of multiple targets is extracted first by aggregating the Doppler FFT samples across all the receive channels by Sample Aggregator 702. The Sample Aggregator stores the samples in Sample Buffer 703.

For each range and Doppler bin, Noncoherent Combiner 704 computes an energy metric equal to the sum of the squares of the samples received on each transmit-receive antenna pair. With up to 18 transmit channels and 24 receive channels, there are up to 432 antenna pairs.

Target Detection in Range 706 takes the energy metric from 704 along with Range Detection Parameters 705 to produce a list of detections in range direction.

List of detections in range direction from 706 are sent to 707 along with the energy metric in 704, all the samples in 703, and Doppler Detection Parameters 708 to produce a list of detections that are present in range and Doppler directions.

Doppler refinement on the list of detections from 707 is performed in 710 using the antenna geometry present in 709.

Using the detection list with refined Doppler from 710 and with the angle estimation parameters in 711, azimuth and elevation angle is estimated in 712 for each target in the detection list.

The list of detections is further refined and pruned in 713 based on the estimated noise variance and the signal-to-noise ratio.

FIG. 8 shows antenna layout according to the embodiments of our invention. In this layout 801, the available transmit antennas are grouped into two groups. Group 1 contains transmit antennas A1 through A9 whereas Group 2 contains transmit antennas A10 through A18. In a similar way, the receive antennas are also grouped into two groups. Group 1 contains receive antennas B1 through B12 whereas Group 2 contains receive antennas B13 through B24.

In Group-1, the spacing of transmit antennas is d10 units whereas the spacing of receive antennas is d11 units. Example units are wavelengths, meters, and inches.

In Group-2, the spacing of transmit antennas is d20 units whereas the spacing of receive antennas is d21 units.

The width of the antenna array is W units whereas the length of the antenna array is L units.

Distances d1, through d8 in FIG. 8 are in the same units as the other distances and are optimized for specific carrier frequency of operation. Example carrier frequencies are within the 76-81 GHz band and 288-292 GHz band.

Transmit antennas A1 through A9 are on the opposite side of receive antennas B13 through B24.

Transmit antennas A10 through A18 are on the opposite side of receive antennas B1 through B12.

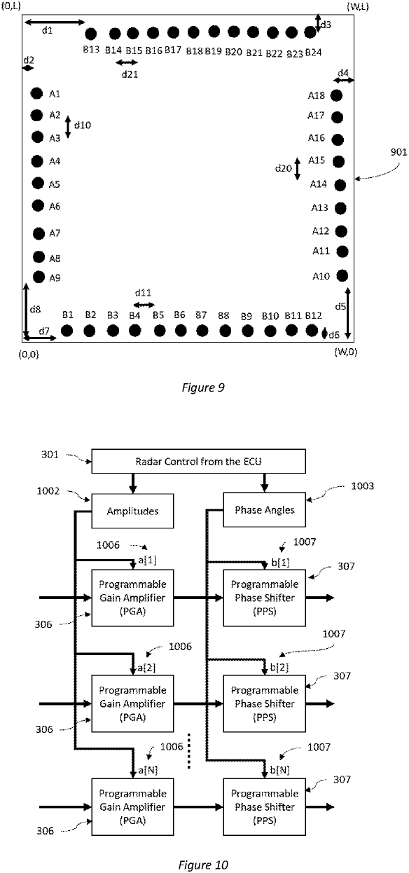

FIG. 9 shows antenna layout according to the embodiments of our invention. In this layout 901, the available transmit antennas are grouped into two groups. Group 1 contains transmit antennas A1 through A9 whereas Group 2 contains transmit antennas A10 through A18. In a similar way, the receive antennas are also grouped into two groups. Group 1 contains receive antennas B1 through B12 whereas Group 2 contains receive antennas B13 through B24.

In Group-1, the spacing of transmit antennas is d10 units whereas the spacing of receive antennas is d11 units.

In Group-2, the spacing of transmits is d20 units whereas the spacing of receive antennas is d21 units.

The width of the antenna array is W units whereas the length of the antenna array is L units.

Distances d1, through d8 in FIG. 9 are in the same units as the other distances and are optimized for specific carrier frequency of operation.

Transmit antennas A1 through A9 are on the opposite side of transmit antennas A10 through A18.

Receive antennas B1 through B12 are on the opposite side of receive antennas B13 through B24.

FIG. 10 shows radar beamforming control including Radar Control from the ECU 301, Amplitudes 1002, Phase Angles 1003, PGA 306 and PPS 307 according to the embodiments of our invention.

The radar control unit 301 is supplied with a vector of amplitudes of length N to control the transmission gain and a vector of phase angles of length N to steering the direction of transmission where N is the number of transmission chains. N is less than or equal to 18.

A vector of N amplitudes is loaded into 1002 and a vector of N phase angles is loaded into 1003.

Each PGA 306 is loaded with one of the amplitudes from a vector of amplitudes from 1002. With ( (a[1],a[2],..,a[N] ) denoting the vector of amplitudes, amplitude a[1] is loaded into the PGA 306 of the first transmit chain, and a[N] is loaded into the PGA 306 of the last transmit chain.

Each PPS 307 is loaded with one of the phase angles from a vector of phase angles from 1003. With ( b[1],b[2],..,b[N] ) denoting the vector of phase angles, angle b[1] is loaded into the PPS 307 of the first transmit chain, and angle b[N] is loaded into the PPS 307 of the last transmit chain.

The radar sensor transmitter is turned off when all the amplitudes are set to zero. That is, by setting a[1] = 0, a[2] = 0,..., a[N] = 0, the sensor does not radiate.

TDM-MIMO (time-division multiplexing with multiple inputs and multiple outputs) radar transmission mode can be realized as follows: We construct a set S that contains the indices of all the transmitter antennas activated for TDM-MIMO. Then, when a chirp is transmitted on antenna k we set a[k] = 1 and a[j] = 0 for all j not equal to k, and both indices k and j are in the set S. We set a[k] = 0 for all indices k that are in the set S.

BF-MIMO (beamforming with MIMO) radar mode can be realized as follows: We construct a set S that contains the indices of all the transmitter antennas activated for BF-MIMO. Then, we set a[k] > 0 for all the indices k in set S, and a[j] = 0 for all the indices j that are not in set S.

FIG. 11 shows interference detection including IQ Sample Pre-Processing 1102, Heat-map Image Generation 1103, Image Pre-processing 1104, and Threshold Detector 1105 according to the embodiments of our invention.

De-compressed IQ Samples 1101 are processed by 1102 to localize potential interference in time and frequency. Example mathematical tools employed are short-term Fourier transform (STFS) and wavelet transforms.

Time-frequency spectrogram is generated by 1103 which is converted into an image.

Image pre-processing techniques such as mean removal, median filtering, and normalization are performed by 1104 to minimize the noise present in the input image.

Threshold Detector 1105 compares the pixel intensity against a threshold. If the intensity is above the threshold then the pixel is classified as a potential interference, the location is recorded and the probability of interference is computed as the ratio of the intensity of the pixel and the intensity of all other pixels that are also classified as potential interference.

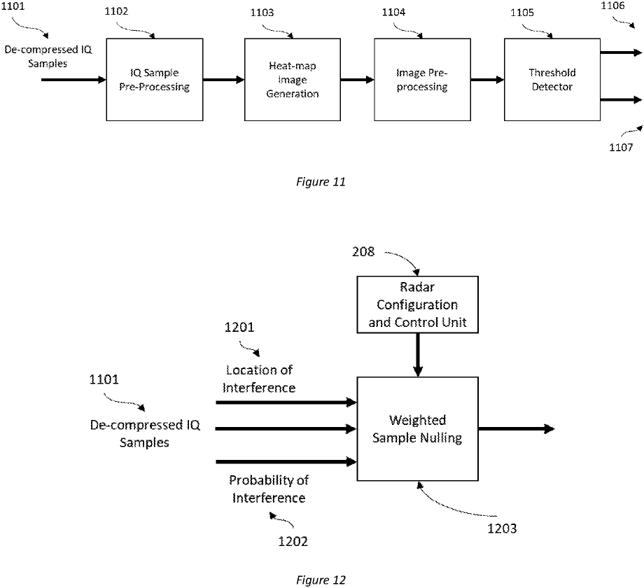

FIG. 12 shows interference mitigation including Weighted Sample Nulling 1203 and Radar Configuration and Control Unit 208 according to the embodiments of our invention.

Weighted Sample Nulling 1203 applies interference mitigation mask on the De-compressed IQ Samples based on the Location of Interference and the Probability of Interference. The higher the probability of interference, the bigger the weight. Additional configuration information from 208 allows 1203 adaptively adjust the weights to create an effective mitigation mask under dynamic interference conditions. The mask length is the same as the length of the De-compressed IQ Samples. The output of 1203 is element-by-element multiplication of mask with the De-compressed IQ Samples.

In example radar use cases such as in automotive applications, target returns on the Radar sensor may contain interference due to potential transmissions from nearby Radar sensors utilizing the same frequency band at the same time. If the interference is not detected, it could lead to higher false detections in the radar signal processing. Once the interference is detected, it must be mitigated to minimize the false alarm and to improve target detection performance. Some of the other interference detection and mitigation procedures that are implemented on the Radar sensor are: M. Umehira, T. Okuda, X. Wang, S. Takeda, H. Kuroda, “An Adaptive Interference Detection and Suppression Scheme Using Iterative Processing for Automotive FMCW Radars”, in 2020 IEEE Radar Conference (RadarConf20). According to the embodiments of our invention, interference detection and mitigation are performed on the ECU based on compressed IQ samples received from the Radar sensor.

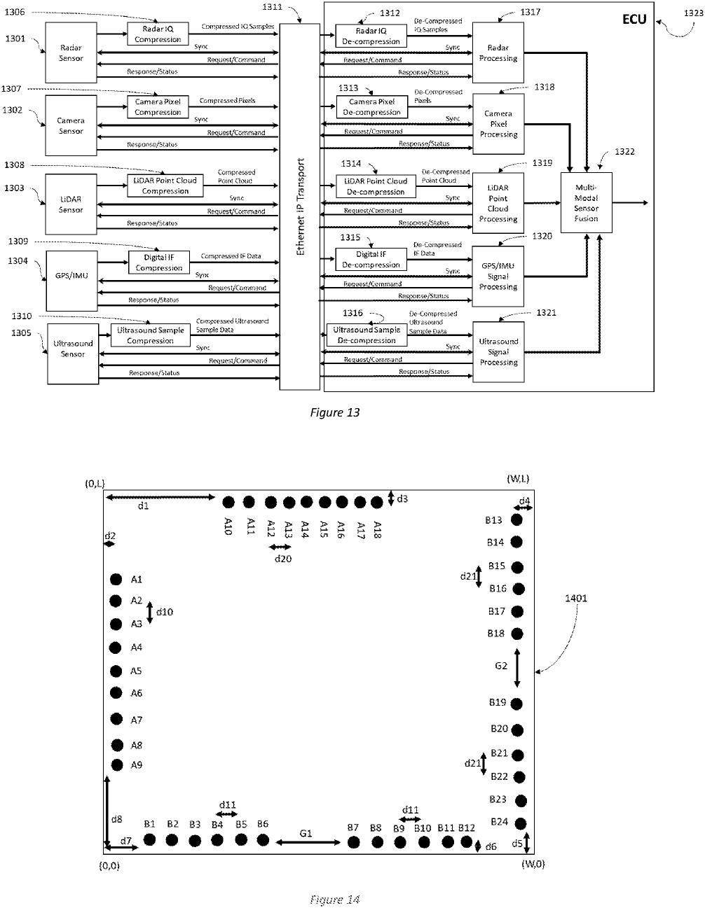

FIG. 13 shows multi-modal sensor fusion using an Ethernet IP (internet protocol) transport including Radar Sensor 1301, Radar IQ Compression 1306, Radar IQ De-Compression 1312, Radar Signal Processing 1317, Camera Sensor 1302, Camera Pixel Compression 1307, Camera Pixel De-Compression 1313, Camera Pixel Processing 1318, Lidar Sensor 1303, Lidar Point Cloud Compression 1308, Lidar Point Cloud De-compression 1314, Lidar Point Cloud Processing 1319, GPS/IMU 1304, Digital IF Compression 1309, Digital IF De-compression 1315, GPS/IMU Signal Processing 1320, Ultrasound Sensor 1305, Ultrasound Sample Compression 1310, Ultrasound Sample De-compression, 1316, Ultrasound Signal Processing 1321, Ethernet IP Transport 1311, Multi-Modal Sensor Fusion 1322, and the ECU 1323 according to the embodiments of our invention.

It is to be noted that for each sensor type, the compression block comprises of a bank of algorithms, or an Algorithm Bank, wherein each algorithm performs a pre-defined type of compression. Similarly, for each sensor type, the de-compression block comprises of an Algorithm Bank wherein each algorithm performs a pre-defined type of decompression.

To implement multi-modal sensor fusion on the ECU with minimal processing on each sensor, we transport compressed data streams of different types of sensors over a single Ethernet IP transport. Radar sensor 1301 transmits uncompressed ADC samples to Radar IQ Compression 1306. These compressed samples are packetized into IP packets and transmitted over the Ethernet IP Transport 1311 to the ECU. The ECU extracts the compressed ADC samples from the Ethernet IP packets and sends it to Radar IQ De-compression 1312 to de-compress the ADC samples. Decompressed ADC samples are then sent to Radar Processing 1317 block to perform range-Doppler-azimuth-elevation estimation of each target present in the radar ADC data. The 4D point cloud of radar signal processing is sent to Multi-Modal Sensor Fusion 1322 to perform sensor fusion with other sensors present on the platform.

Camera Sensor 1302 sends uncompressed pixels to Camera Pixel Compression 1307. Compressed pixel from 1307 are packetized into IP packets and transmitted over the Ethernet IP Transport 1311 to the ECU. The ECU extracts the compressed pixels from the Ethernet IP packets and sends it to Camera Pixel De-compression 1313 to de-compress the pixels. Decompressed camera pixels are then sent to Camera Pixel Processing 1318 to perform object detection. Detected objects are sent to Multi-Modal Sensor Fusion 1322 to perform sensor fusion with other sensors present on the platform.

LiDAR Sensor 1303 sends uncompressed point cloud data to LiDAR Point Cloud Compression 1308. A point in the LiDAR point cloud comprises of location of the point in Cartesian coordinates, or polar coordinates, along with the intensity of the point. Compressed point cloud from 1308 are packetized into IP packets and transmitted over the Ethernet IP Transport 1311 to the ECU. The ECU extracts the compressed point clouds from the Ethernet IP packets and sends it to LiDAR Point Cloud De-compression 1314 to de-compress the point cloud data. Decompressed point cloud data is then sent to LiDAR Point Cloud Processing 1319 to perform object detection and semantic segmentation. Semantic segmentation information along with the list of detected objects is sent to Multi-Modal Sensor Fusion 1322 to perform sensor fusion with other sensors present on the platform.

GPS/IMU Sensor 1304 sends uncompressed digital IF samples to Digital IF Compression 1309. A digital IF sample is either a real or a complex-valued sample at a lower frequency compared with the carrier frequency of operation. Compressed IF data from 1309 are packetized into IP packets and transmitted over the Ethernet IP Transport 1311 to the ECU. The ECU extracts the compressed IF data from the Ethernet IP packets and sends it to Digital IF De-compression 1315 to de-compress the compressed IF data. Decompressed IF data is then sent to GPS/IMU Signal Processing 1320 to estimate the position, velocity and acceleration of the ego vehicle. Vehicle location information is sent to Multi-Modal Sensor Fusion 1322 to perform sensor fusion with other sensors present on the platform.

Ultrasound Sensor 1305 sends uncompressed ultrasound data to Ultrasound Sample Compression 1310. Compressed ultrasound data samples from 1310 are packetized into IP packets and transmitted over the Ethernet IP Transport 1311 to the ECU. The ECU extracts the compressed Ultrasound data samples from the Ethernet IP packets and sends it to Ultrasound Sample De-compression 1316 to de-compress the ultrasound data samples. Decompressed ultrasound data samples are then sent to Ultrasound Signal Processing 1321 to perform object detection. List of detected objects from the ultrasound signal processing is sent to Multi-Modal Sensor Fusion 1322 to perform sensor fusion with other sensors present on the platform.

The ECU establishes time synchronization with each sensor present on the platform. Example Ethernet time synchronization protocol includes IEEE 1588 based precision-time protocol (PTP) that is running on both the sensor and the ECU with the PTP on the ECU is configured as the master.

The ECU configures each sensor present on the platform over the Ethernet interface to enable certain functionalities on the sensor. The configuration from the ECU is realized via Requests and Commands. Example Request/Commands include turn-on one or more sub-systems on the sensor, turn-off one or more sub-systems on the sensor, report the power levels, report the status of the sensor, and perform sensor calibration.

The ECU sends a Response/Status command to a sensor over the Ethernet interface to receive the status information from that sensor over the same Ethernet interface. With each sensor present on the platform the ECU maintains Sync interface for time synchronization, Request/Command interface to command the sensor to perform certain actions, and Response/Status interface to receive status information from the sensor.

Although FIG. 13 depicts one sensor per sensor modality, it is to be understood that multiple sensors of a given modality are transported on the same Ethernet IP transport.

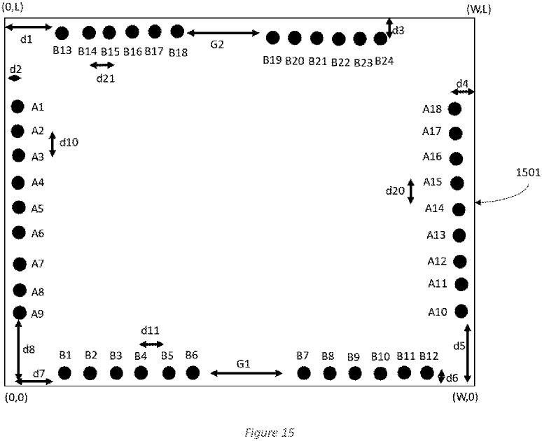

FIG. 14 shows antenna layout according to the embodiments of our invention. In this layout 1401, the available transmit antennas are grouped into two groups. Group 1 contains transmit antennas A1 through A9 whereas Group 2 contains transmit antennas A10 through A18. In a similar way, the receive antennas are also grouped into two groups. Group 1 contains receive antennas B1 through B12 whereas Group 2 contains receive antennas B13 through B24.

In Group-1, the spacing of transmit antennas is d10 units.

In Group-2, the spacing of transmit antennas is d20 units.

The receive antennas in Group-1 are split into two subgroups. The first subgroup contains 6 receive antennas and the second subgroup contains 6 receive antennas. The spacing of receive antennas within each subgroup of Group-1 is d11 and the separation between the two subgroups within Group-1 is G1.

The receive antennas in Group-2 are split into two subgroups. The first subgroup contains 6 receive antennas and the second subgroup contains 6 receive antennas. The spacing of receive antennas within each subgroup of Group-2 is d21 and the separation between the two subgroups within Group-2 is G2.

The width of the antenna array is W units whereas the length of the antenna array is L units.

Distances d1 through d8 in FIG. 14 are in the same units as the other distances and are optimized for specific carrier frequency of operation.

Transmit antennas A1 through A9 are on the opposite side of receive antennas B13 through B24.

Transmit antennas A10 through A18 are on the opposite side of receive antennas B1 through B12.

FIG. 15 shows antenna layout according to the embodiments of our invention. In this layout 1501, the available transmit antennas are grouped into two groups. Group 1 contains transmit antennas A1 through A9 whereas Group 2 contains transmit antennas A10 through A18. In a similar way, the receive antennas are also grouped into two groups. Group 1 contains receive antennas B1 through B12 whereas Group 2 contains receive antennas B13 through B24.

In Group-1, the spacing of transmit antennas is d10 units.

In Group-2, the spacing of transmit antennas is d20 units.

The receive antennas in Group-1 are split into two subgroups. The first subgroup contains 6 receive antennas and the second subgroup contains 6 receive antennas. The spacing of receive antennas within each subgroup of Group-1 is d11 and the separation between the two subgroups within Group-1 is G1.

The receive antennas in Group-2 are split into two subgroups. The first subgroup contains 6 receive antennas and the second subgroup contains 6 receive antennas. The spacing of receive antennas within each subgroup of Group-2 is d21 and the separation between the two subgroups within Group-2 is G2.

The width of the antenna array is W units whereas the length of the antenna array is L units.

Distances d1, through d8 in FIG. 15 are in the same units as the other distances and are optimized for specific carrier frequency of operation.

Transmit antennas A1 through A9 are on the opposite side of transmit antennas A10 through A18.

Receive antennas B1 through B12 are on the opposite side of receive antennas B13 through B24.

1. A method for implementing a multi-modal sensor system where sensor signal and data processing is split between the sensor and the ECU.

2. A method for communicating between the ECU and a plurality of sensors.

3. The method of claim 2, wherein the sensor type is a Radar sensor.

4. The method of claim 2, wherein the sensor type is a Camera sensor.

5. The method of claim 2, wherein the sensor type is a LiDAR sensor.

6. The method of claim 2, wherein the sensor type is a GPS/IMU sensor.

7. The method of claim 2, wherein the sensor type is an Ultrasound sensor.

8. A method of compressing the data generated by a plurality of sensors.

9. A method of claim 8, wherein the sensor type is a Radar sensor.

10. A method of claim 8, wherein the sensor type is a Camera sensor.

11. A method of claim 8, wherein the sensor type is a LiDAR sensor.

12. A method of claim 8, wherein the sensor type is a GPS/IMU sensor.

13. A method of claim 8, wherein the sensor type is an Ultrasonic sensor.

14. A method of packetizing the compressed data generated by a plurality of sensors.

15. A method of claim 14, wherein the sensor type is a Radar sensor.

16. A method of claim 14, wherein the sensor type is a Camera sensor.

17. A method of claim 14, wherein the sensor type is a LiDAR sensor.

18. A method of claim 14, wherein the sensor type is a GPS/IMU sensor.

19. A method of claim 14, wherein the sensor type is an Ultrasonic sensor.

20. A method of transporting over the Ethernet of packetized compressed data generated by a plurality of sensors.

21. A method of claim 20, wherein the sensor type is a Radar sensor.

22. A method of claim 20, wherein the sensor type is a Camera sensor.

23. A method of claim 20, wherein the sensor type is a LiDAR sensor.

24. A method of claim 20, wherein the sensor type is a GPS/IMU sensor.

25. A method of claim 20, wherein the sensor type is an Ultrasonic sensor.

26. A method of extracting packetized compressed data transported over the Ethernet generated by a plurality of sensors.

27. A method of claim 26, wherein the sensor type is a Radar sensor.

28. A method of claim 26, wherein the sensor type is a Camera sensor.

29. A method of claim 26, wherein the sensor type is a LiDAR sensor.

30. A method of claim 26, wherein the sensor type is a GPS/IMU sensor.

31. A method of claim 26, wherein the sensor type is an Ultrasonic sensor.

32. A method of decompression of data generated by a plurality of sensors.

33. A method of claim 32, wherein the sensor type is a Radar sensor.

34. A method of claim 32, wherein the sensor type is a Camera sensor.

35. A method of claim 32, wherein the sensor type is a LiDAR sensor.

36. A method of claim 32, wherein the sensor type is a GPS/IMU sensor.

37. A method of claim 32, wherein the sensor type is an Ultrasonic sensor.

38. A method of establishing time synchronization over Ethernet IP transport with a plurality of sensors.

39. A method of claim 38, wherein the sensor type is a Radar sensor.

40. A method of claim 38, wherein the sensor type is a Camera sensor.

41. A method of claim 38, wherein the sensor type is a LiDAR sensor.

42. A method of claim 38, wherein the sensor type is a GPS/IMU sensor.

43. A method of claim 38, wherein the sensor type is an Ultrasonic sensor.

44. A method of configuring over Ethernet IP transport a plurality of sensors.

45. A method of claim 44, wherein the sensor type is a Radar sensor.

46. A method of claim 44, wherein the sensor type is a Camera sensor.

47. A method of claim 44, wherein the sensor type is a LiDAR sensor.

48. A method of claim 44, wherein the sensor type is a GPS/IMU sensor.

49. A method of claim 44, wherein the sensor type is an Ultrasonic sensor.

50. A method for performing radar signal processing on the ECU with compressed IQ samples transmitted over the Ethernet interface from a plurality of Radar sensors to the ECU.

51. A method for performing camera pixel processing on the ECU with compressed camera pixels transmitted over the Ethernet interface from a plurality of Camera sensors to the ECU.

52. A method for performing LiDAR point cloud processing on the ECU with compressed point cloud data transmitted over the Ethernet interface from a plurality of LiDAR sensors to the ECU.

53. A method for performing GPS/IMU signal processing on the ECU with compressed digital IF data transmitted over the Ethernet interface from a plurality of GPS/IMU sensors to the ECU.

54. A method for performing ultrasound signal processing on the ECU with compressed ultrasound sample data transmitted over the Ethernet interface from a plurality of ultrasound sensors to the ECU.

55. A method for transmitting digital waveform samples from the ECU to the Radar sensor over the Ethernet interface.

56. A method for interference detection on the ECU based on the compressed IQ samples received over the Ethernet interface from the Radar sensor.

57. A method for interference mitigation on the ECU based on the compressed IQ samples received over the Ethernet interface from the Radar sensor.

58. A method for transmit beamforming on the Radar sensor based on compressed digital beamforming samples received from the ECU over the Ethernet interface.

59. A method to orient 18 transmit antennas and 24 receive antennas on a rectangular antenna board with equal number of transmit antennas with uniform spacing placed on two opposite sides, and equal number of receive antennas with uniform spacing placed on the remaining two opposite sides.

60. A method of claim 59, wherein the number of receive antennas on a side are split into two groups each having 6 antennas with uniform spacing within a group.

61. A method to orient 18 transmit antennas and 24 receive antennas on a rectangular antenna board with equal number of transmit antennas with uniform spacing placed on two adjacent sides, and equal number of receive antennas with uniform spacing placed on the remaining two adjacent sides.

62. A method of claim 61, wherein the number of receive antennas on a side are split into two groups each having 6 antennas with uniform spacing within a group.
